(19) United States
(12) Patent Application Publication
(10) Pub. No.: US 2011/0274793 A1
(43) Pub. Date: Nov. 10, 2011

(54) PURIFIED ALGINIC ACID OR SALT THEREOF

(75) Inventor: Tomohisa Ichiba, Tokyo (JP)

(73) Assignee: Kao Corporation, Chuo-ku, Tokyo (JP)

(21) Appl. No.: 13/144,980

(22) PCT Filed: Jan. 19, 2010
(86) PCT No.: PCT/JP2010/000272

§ 371 Date: Jul. 18, 2011

(30) Foreign Application Priority Data
Jan. 20, 2009 (JP) 2009-009549
Sep. 10, 2009 (JP) 2009-209159

(51) Int. Cl. A23L 2/00; C08B 37/04

(52) U.S. Cl. 426/106; 536/3

(57) ABSTRACT

There is provided a purified alginic acid or a salt thereof having a low degree of coloration and a process for producing the same.

A depolymerized alginic acid or a salt thereof having a weight-average molecular weight of 300,000 or lower, wherein a degree of coloration, which is defined as the difference in absorbance between 420 nm and 720 nm when a 5% by weight aqueous solution of the alginic acid or a salt thereof is subjected to absorption spectrophotometry using a 1-cm cell, is 0.040 or lower.

### FIELD OF THE INVENTION

The present invention relates to a purified alginic acid or a salt thereof, and a method of producing the same.

### BACKGROUND OF THE INVENTION

Alginic acid is a high-molecular-weight polyuronic acid composed of β-D-mannuronic acid and α-L-guluronic acid, linked together in various ratios, and has been used as a dietary fiber. Alginic acid is also known to exert a large number of effects on health. Alginic acid or a salt thereof (hereinafter sometimes referred to as alginic acid (salt)) has recently been utilized actively as a raw material for Foods for Specified Health Use, the labeling of which is permitted by the Ministry of Health, Labor and Welfare because of its effects of regulating intestinal functions and/or lowering cholesterol level.

Although alginic acid (salt) has various excellent physiologically active functions described above, it could have been used only as a dilute solution of an emulsion stabilizer, a thickener, etc., due to its high viscosity when dissolved in water. Alginic acid (salt) is thus used as a powder as it is when a high concentration is needed.

In view of this, techniques for depolymerizing alginic acid (salt) have conventionally been known. As a method for depolymerizing alginic acid, a method in which an acidic aqueous solution of alginic acid is prepared and heated is generally known, for example. Also known is a method in which depolymerization is performed under pressure and heat (Patent Document 1). Since the depolymerized alginic acid (salt) thus obtained is colored brown, however, it was difficult to apply it to uses requiring a low degree of coloration. Further, when it was applied to uses where a certain color is required, it was difficult to adjust the color to a desired color.

A method of producing highly purified depolymerized alginic acid (salt) is also disclosed, in which alginic acid (salt) is hydrolyzed with phosphoric acid (Patent Document 2). The aqueous solution of the depolymerized alginic acid (salt) produced by this method is also colored brown, however, and its application is also limited.

Meanwhile, foods containing alginic acid (salt), as foods for specified health uses, include soft drinks and soups (as of Oct. 29, 2008). Any of these foods for specified health is not required to be colorless as a product. Since there has been no alginic acid (salt) having a reduced degree of coloration so far, it is difficult to develop foods which need to be highly colorless, such as near waters and jellies, and it is desired to develop alginic acid (salt) having a low degree of coloration to resolve the problem.

### PRIOR ART DOCUMENTS

### Patent Documents

[Patent Document 1] JP-A-6-7093
[Patent document 1] JP-A-11-80204

### DISCLOSURE OF THE INVENTION

The present invention provides a depolymerized alginic acid or a salt thereof having a weight-average molecular weight of 300,000 or lower, wherein a degree of coloration, which is defined as the difference in absorbance at 420 nm and 720 nm when a 5% by weight aqueous solution of the alginic acid or a salt thereof is subjected to absorption spectrophotometry using a 1-cm cell, is 0.040 or lower.

The present invention also provides a depolymerized alginic acid or a salt thereof having a weight-average molecular weight of 300,000 or lower, containing 0.001 to 0.3% by weight of alginic acid or a salt thereof having a molecular weight of 1,800 or lower.

The present invention also provides a food containing the depolymerized alginic acid or a salt thereof.

The present invention also provides a method of producing a purified alginic acid or a salt thereof, including a step of adjusting the pH of an aqueous solution of a raw material depolymerized alginic acid or a salt thereof having a weight-average molecular weight of 300,000 or lower to 1 to 3.5, and a step of isolating the resulting precipitate.

The present invention also provides a method of producing a purified alginic acid or a salt thereof, including a step of treating an aqueous solution of a raw material depolymerized alginic acid or a salt thereof having a weight-average molecular weight of 300,000 or lower with an ultrafiltration membrane having a molecular weight cut-off of 2,000 to 30,000.

### DETAILED DESCRIPTION OF THE INVENTION

The present invention relates to provision of a highly purified alginic acid (salt) having a low degree of coloration. The present invention also relates to provision of food and drink using the highly purified alginic acid (salt).

The present inventors have found that a low-molecular-weight alginic acid (salt) which has conventionally been put on the market is especially colored brown compared to a high-molecular-weight alginic acid (salt). This coloration is considered to be caused by the depolymerizing process in which a high-molecular-weight alginic acid (salt) is converted into a depolymerized alginic acid (salt). In view of this, it has been attempted to purify the depolymerized alginic acid (salt) through a commonly known purification process, such as an activated carbon treatment or solvent washing, but no remarkable effect could be obtained.

The present inventors have eagerly studied about the above problems, and found that low-molecular-weight components of the depolymerized alginic acid (salt), in particular, are causative substances of the coloration, and that the colored components do not precipitate under an acidic condition and exist in a dissolved state. Based on this finding, the present inventors have found that a purified alginic acid or a salt thereof having a low degree of coloration can be obtained through dissolving a colored low-molecular-weight alginic acid (salt) in an aqueous solution, and after that lowering the pH of the resulting solution to precipitate non-colored components in the aqueous solution, followed by isolating the precipitate from the water-soluble colored components. Meanwhile, the present inventors have also found that a purified alginic acid or a salt thereof having a low degree of coloration can be obtained by treating an aqueous solution containing a colored low-molecular-weight alginic acid (salt) dissolved therein with a specific ultrafiltration membrane through which colored components can permeate but non-colored components cannot.

The method of treating alginic acid or a salt thereof with the addition of an acid is commonly used when alginic acid or a salt thereof is extracted from a tangle or is depolymerized. It is known that coloration of alginic acid occurs in the depolymerization with an acid. It was therefore expected that the acid treatment rather resulted in the coloration. However, it has been unexpectedly found that a purified depolymerized alginic acid having a low degree of coloration can be obtained through dissolving an already depolymerized alginic acid salt in an aqueous solution, after that, adding an acid to the resultant solution to lower the pH and to cause precipitation in the aqueous solution, and then isolating the precipitate.

The purified alginic acid or a salt thereof of the present invention has a low degree of coloration. Since the purified alginic acid or a salt thereof of the present invention causes only a little change in its hue when it is incorporated, the scope of its application can be extended to foods which are especially needed to be colorless.

The purified alginic acid or a salt thereof of the present invention is a depolymerized alginic acid or a salt thereof having a weight-average molecular weight of 300,000 or lower and having a degree of coloration of 0.040 or lower, where the degree of coloration is defined as the difference in absorbance at 420 nm and 720 nm when a 5% by weight aqueous solution of the alginic acid or a salt thereof is subjected to absorption spectrophotometry using a 1-cm cell. The degree ranging from brown to black can be judged by using such a degree of coloration. The degree of coloration exceeding 0.040 corresponds to a brownish color and that of 0.040 or lower corresponds to an almost colorless state. A preferable degree of coloration is 0.03 or lower (0 to 0.03).

The weight-average molecular weight of the purified alginic acid (salt) of the present invention is 300,000 or lower, but is preferably 200,000 or lower, more preferably 180,000 or lower, even more preferably 150,000 or lower, even more preferably 100,000 or lower, even more preferably 70,000 or lower. The lower limit of the weight-average molecular weight is preferably 10,000 or higher, more preferably 15,000 or higher, even more preferably 20,000 or higher, even more preferably 22,000 or higher. In the past, there was no alginic acid (salt) having such a low molecular weight and having a degree of coloration of 0.040 or lower.

In the purified alginic acid (salt) of the present invention, the content of low-molecular-weight components is reduced. The low-molecular-weight alginic acid (salt) is considered to be the component responsible for the coloration. More specifically, in the purified alginic acid (salt) of the present invention, the content of alginic acid (salt) having a molecular weight of 1,800 or lower is preferably 0.3% by weight or lower, more preferably 0.001 to 0.3% by weight, even more preferably 0.001 to 0.2% by weight, even more preferably 0.01 to 0.2% by weight.

The purified alginic acid (salt) of the present invention has a small polydispersity (Mw/Mn=a weight-average molecular weight/a number-average molecular weight). The polydispersity is preferably 1 to 2.6, more preferably 1 to 2.3, even more preferably 1 to 2.2.

The purified alginic acid (salt) of the present invention is preferably produced through a process including a step of adjusting the pH of an aqueous solution of a raw material depolymerized alginic acid or a salt thereof having a weight-average molecular weight of 300,000 or lower to 3.5 or lower and a step of isolating the resulting precipitate; or through a process including a step of treating an aqueous solution of a raw material depolymerized alginic acid (salt) having a weight-average molecular weight of 300,000 or lower with an ultrafiltration membrane having a molecular weight cut-off of 2,000 to 30,000.

The raw material alginic acid (salt) to be used in the method of producing a purified alginic acid (salt) of the present invention is a depolymerized alginic acid (salt), namely alginic acid (salt) having a weight-average molecular weight of 300,000 or lower, whose 5% by weight aqueous solution has a degree of coloration of higher than 0.04. There is no particular limitation on the ratio or arrangement sequence of β-D-mannuronic acid and α-L-guluronic acid which constitute the alginic acid (salt). Accordingly, alginic acid (salt) containing all of a block consisting of β-D-mannuronic acid alone, a block consisting of α-L-guluronic acid alone, and a block consisting of a mixture thereof may be used; or alginic acid or a salt thereof containing any one or two of the blocks may be used. The weight-average molecular weight of a raw material depolymerized alginic acid (salt) is preferably 200,000 or lower, more preferably 180,000 or lower, even more preferably 150,000 or lower, even more preferably 100,000 or lower, even more preferably 70,000 or lower.

The method of producing a purified alginic acid (salt) of the present invention is performed in an aqueous solution of alginic acid (salt). The concentration is not particularly limited, but is preferably 50% by weight or lower, more preferably 0.1 to 20% by weight, even more preferably 0.5 to 15% by weight, even more preferably 1 to 10% by weight from the viewpoint of efficiently removing the colored components. The solvent is preferably water.

In the method of the present invention, an aqueous solution containing depolymerized alginic acid (salt) is adjusted to pH 3.5 or lower. By adjusting the pH to 3.5 or lower, alginic acid (salt) is efficiently isolated from colored components, resulting in purified alginic acid (salt) having a low degree of coloration. The pH is preferably 0.5 to 3.5, more preferably 1 to 3.5, even more preferably 1 to 3 from the viewpoints that the colored components can be efficiently separated and hydrolysis hardly occurs. Although alginic acid (salt) is precipitated also by using an organic solvent, such as methanol and ethanol, use of an organic solvent is not preferable from the viewpoint of efficient separation of colored components.

A pH regulator is not particularly limited as far as it can regulate pH to 3.5 or lower, and includes, for instance, organic acid salts; such as acetic acid, citric acid, fumaric acid, malic acid, lactic acid, gluconic acid, and tartaric acid; inorganic salts; such as phosphoric acid, hydrochloric acid, sulfuric acid, and carbonic acid; and a mixture thereof. In view that the purified alginic acid (salt) of the present invention is used mainly in foods, as mentioned above, it is desired that these acids can be used in products of foods or food additives even when they remain in the purified alginic acid (salt). From these points, the above acids are preferably of the grade of food additives.

The temperature for the treatment is not particularly limited, but is preferably 0 to 80° C., more preferably 0 to 50° C. Time period required for the treatment is not particularly limited, but generally is preferably within the range of 1 minute to 100 hours, more preferably 2 minutes to 24 hours, even more preferably 3 minutes to 12 hours, even more preferably 5 minutes to 6 hours, even more preferably 10 minutes to 3 hours from the viewpoints that colored components can be efficiently separated and hydrolysis does not occur.

Isolation of the precipitate from the supernatant solution after treatment may be performed through centrifugation or filtration. A purified alginic acid having a further lower degree of coloration can be obtained by adding water to the isolated precipitate to wash it and isolating the resulting re-precipitate in the same way as mentioned above.

A purified alginic acid may be obtained by drying the precipitate obtained in the above process by freeze-drying, spray drying, or the like, and a purified alginic acid salt may be obtained by neutralizing the purified alginic acid with an alkali metal hydroxide, alkali metal carbonate, or the like, and drying the resultant in the same way. Since the purified alginic acid salt of the present invention is mainly used for foods, however, the alginic acid salt should be those specified as a food additive. Accordingly, it is preferable to obtain, as a presently usable alginic acid salt, sodium alginate, potassium alginate, calcium alginate, or ammonium alginate.

In the present invention, the aqueous solution containing a depolymerized alginic acid (salt) may be also treated with an ultrafiltration membrane whose molecular weight cut-off is 2,000 to 30,000. When the molecular weight cut-off of the ultrafiltration membrane is 2,000 or higher, a filtration rate is high, and when the cut-off is 30,000 or lower, the alginic acid (salt) is easily isolated from colored components, resulting in a good color tone.

The molecular weight cut-off of the ultrafiltration membrane is more preferably 3,000 to 20,000, even more preferably 4,000 to 10,000. The molecular weight cut-off can be measured by observing whether a substance having a known molecular weight, as a marker, can be separated by the membrane to be measured. Examples of the marker include Vitamin B12, cytochrome C, y globulin, and blue dextran.

Examples of the ultrafiltration membrane include polymer membranes, such as hydrocarbon, fluorinated hydrocarbon, sulfone, and nitrile membranes; and ceramic membranes, such as Membralox. Among these, it is preferable to use a polymer membrane since it needs a short time for filtration and is good in efficiency.

Examples of the hydrocarbon, fluorinated hydrocarbon, or sulfone polymer membrane include polyolefin polymer membranes, such as polyethylene and polypropylene membranes; fluorinated polyolefin polymer membranes, such as polytetrafluoroethylene (PTFE) and polyvinylidene difluoride (PVDF) membranes; and sulfone polymer membranes, such as polysulfone (PSU) and polyethersulfone (PES) membranes. Specifically, for instance, commercially available products, such as AIP-0013D (polyacrylonitrile membrane: product of Asahi Kasei Chemicals Corp.), SEP-0013 (polysulfone membrane: product of Asahi Kasei Chemicals Corp.), SIP-0013 (polysulfone membrane: product of Asahi Kasei Chemicals Corp.), SLP-0013 (polysulfone membrane: product of Asahi Kasei Chemicals Corp.), and Biomax PBCC (PES membrane: product of Millipore Corp.) may be used.

The form of the ultrafiltration membrane is not particularly limited, and may be a sheet form, a hollow fiber form, or the like. It is preferable to use a hollow fiber form, however, since a undiluted liquid is passed parallel to the surface of the membrane of the hollow fiber so that clogging can be suppressed and filtration performance can be stably maintained. The inner diameter of the membrane in the case of the hollow fiber form is preferably 0.5 to 2 mm, more preferably 0.6 to 1.8 mm, even more preferably 0.8 to 1.5 mm.

As conditions of ultrafiltration, the temperature is preferably 5 to 70° C., more preferably 10 to 40° C. in terms of heat resistance of the ultrafiltration membrane. The pressure is preferably within the range of a pressure resistance of the membrane module to be used. For instance, the pressure is preferably 30 to 1,000 kPa, more preferably 50 to 800 kPa, even more preferably 100 to 700 kPa.

After the treatment, a purified alginic acid (salt) can be obtained by collecting the condensate and drying it through freeze-drying, spray drying, or the like.

The purified alginic acid (salt) of the present invention has a low degree of coloration and therefore can be applied to various foods and drinks.

Examples of the products using the purified alginic acid (salt) of the present invention include foods containing the purified alginic acid (salt). Specific foods include beverages, jellies, creams, noodles, sauces, soups, rice cakes, and the like. In order to effectively exhibit the effect of the low degree of coloration of the purified alginic acid (salt) of the present invention, jellies, sauces, noodles, and the like are preferable.

Examples of the beverages include specifically drinks such as soft drinks, carbonated drinks, energy drinks, fruit drinks, milk drinks (including concentrate liquid and instant powder to prepare these drinks); and jelly drinks. More preferable is a beverage, such as near water, which is required to have a low degree of coloration.

The content of the purified alginic acid (salt) in foods or drinks is preferably 0.1 to 10% by weight, more preferably 0.5 to 5% by weight.

### EXAMPLES

Hereinafter, the present invention will be explained with reference to Examples.

### (Method of Measuring the Degree of Coloration)

In the present invention, the degree of coloration is measured by the following method. At first, water is added to alginic acid (salt) to prepare a 5.0% by weight aqueous solution of alginic acid (salt). The resulting solution is subjected to filtration through a membrane filter having an opening size of 0.45 μm (GL Chromatodisk). The resulting filtrate is poured into a silica glass cell of 1-cm square, and absorbance is measured at 420 nm and 720 nm with a spectrophotometer (U-2910: product of Hitachi Ltd.). The degree of coloration is then defined by a value obtained by subtracting the absorbance at 720 nm from the absorbance at 420 nm.

(Method of measuring a weight-average molecular weight (Mw) and method of measuring polydispersity (Mw/Mn))
1. Pretreatment (preparation of an analysis sample)

Distilled water is added to 0.1 g of alginic acid (salt) to prepare a 0.1% solution thereof, which is used as an analysis sample.

2. 100 μL of the analysis sample is measured by gel permeation chromatography (GPC). The GPC operating conditions are shown below. As a calibration curve for calculating a molecular weight, standard pullulan (Shodex STANDARD P-82: product of Showa Denko K.K.) is used. Next, the weight-average molecular weight and the number-average molecular weight of the alginic acid (salt) in the sample are measured.

The amount of the alginic acid (salt) having a molecular weight of 1,800 or lower can be obtained by plotting each amount against each molecular weight based on the result of the GPC measurement; integrating the area of the part indicating molecular weight of 1800 or lower; and calculating the ratio of the area to the whole area of the alginic acid (salt).

### Column:

(1) Super AW-L (product of Tosoh Corp.)
(2) TSK-GEL Super AW4000 (product of Tosoh Corp.)
   TSK-GEL Super AW2500 (product of Tosoh Corp.)
      Temperature of column: 40° C.
      Detector: A differential refractometer
      Mobile phase: A 0.2 mol/L aqueous solution of sodium nitrate
      Flow rate: 0.6 mL/min
      Injection volume: 100 μL

### Example 1

10 g of potassium alginate (SKAT-K-ULV: product of Kimica Corp.) having a weight-average molecular weight of 45,000 and a degree of coloration of a 5% by weight aqueous solution of 0.078 was dissolved in 90 g of water, and the pH of the resulting solution was adjusted to 2.0 with hydrochloric acid. After stirring for 10 minutes, the solution was centrifuged (3,000 rpm, 10 min) and the precipitate was collected. To the precipitate thus obtained, 90 g of water was added, and the precipitate was thoroughly dispersed. After that, the dispersion was again centrifuged (3,000 rpm, 10 min), and the precipitate was collected. An aqueous solution of potassium hydroxide was then added to adjust the pH to 7, and the resulting mixture was thoroughly dried with a freeze dryer to obtain a purified potassium alginate. All the operations were conducted at room temperature (25° C.).

### Example 2

A purified alginic acid (salt) was obtained in the same manner as in Example 1, except that potassium alginate having a degree of coloration of a 5% by weight aqueous solution of 0.049 and a weight-average molecular weight of 31,000 (Kariarugin K-3: product of Food Chemifa Co., Ltd.) was used as a starting material.

### Example 3

A purified sodium alginate was obtained in the same manner as in Example 1, except that sodium alginate having a degree of coloration of a 5% by weight aqueous solution of 0.042 and a weight-average molecular weight of 54,000 (Solgin: product of Kaigen Co., Ltd.) was used as a starting material and further that sodium hydroxide was used in place of potassium hydroxide.

The degree of coloration of the 5% by weight aqueous solution, the weight-average molecular weight, the polydispersity, and the content of the molecules having a molecular weight of 1,800 or lower (% by weight) of the obtained alginic acid (salt) are shown in Table 1. The results shown in Table 1 prove that the alginic acid (salt) having a degree of coloration of a 5% by weight aqueous solution of higher than 0.040 is converted into a purified alginic acid (salt) having a degree of coloration of a 5% by weight aqueous solution of 0.040 or lower through the treatment method of the present invention.

### Comparative Example 1

A 5% by weight solution of potassium alginate (SKAT-K-ULV: product of Kimica Corp.) having a weight-average molecular weight of 45,000 which was used in Example 1 was prepared. The degree of coloration of this solution was measured and found to be 0.078.

### Comparative Example 2

A 5% by weight solution of potassium alginate (Kalialgin K-3: product of Food Chemifa Co., Ltd.) having a weight-average molecular weight of 31,000 which was used in Example 2 was prepared. The degree of coloration of this solution was measured and found to be 0.049.

### Comparative Example 3

A 5% by weight solution of sodium alginate (Solgin: product of Kaigen Co., Ltd.) having a weight-average molecular weight of 54,000 which was used in Example 3 was prepared. The degree of coloration of this solution was measured and found to be 0.042.

### Comparative Example 4

Water was added to the potassium alginate having a weight-average molecular weight of 45,000 (SKAT-K-ULV: product of Kimica Corp.) used in Example 1, the potassium alginate was dissolved therein, and after that ethanol was added to the resulting solution to prepare an 80% ethanol solution, followed by thorough stirring and washing. The resulting solution was then centrifuged (3,000 rpm, 10 min), and the precipitate was collected and thoroughly dried with a freeze dryer to obtain a purified potassium alginate.

The degree of coloration of the 5% by weight aqueous solution, the weight-average molecular weight, the polydispersity, and the content of the molecules having a molecular weight of 1,800 or lower (% by weight) of the obtained alginic acid (salt) are shown in Table 1. The results shown in Table 1 prove that the degree of coloration of a 5% by weight aqueous solution of the alginic acid (salt) obtained was 0.066. This result indicates that colored components contained in alginic acid (salt) cannot be thoroughly removed by this method.

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| pH (1%) | 6.6 | 6.8 | 7.4 | 6.2 | 7.4 | 6.5 | 6.2 |
| 420 nm (5%) | 0.021 | 0.025 | 0.035 | 0.086 | 0.051 | 0.044 | 0.071 |
| 720 nm (5%) | 0.001 | 0.003 | 0.005 | 0.008 | 0.002 | 0.002 | 0.005 |
| Degree of coloration | 0.020 | 0.022 | 0.030 | 0.078 | 0.049 | 0.042 | 0.066 |
| Weight-average molecular weight | 52,000 | 42,000 | 69,000 | 45,000 | 31,000 | 54,000 | 46,000 |
| Polydispersity | 1.96 | 2.10 | 2.19 | 2.24 | 2.74 | 2.49 | 2.25 |
| Content (%) of molecules having a | 0.14 | 0.28 | 0.13 | 0.36 | 2.38 | 0.55 | 0.38 |
| molecular weight of 1,800 or lower | | | | | | | |

### Example 4

1.0 g of potassium alginate (SKAT-K-ULV: product of Kimica Corp.) having a weight-average molecular weight of 45,000 and a degree of coloration of the 5% by weight aqueous solution of 0.078 was dissolved into 99.0 g of water. The resulting aqueous solution was placed in a stirred cell (Stirred cell Model 8050: product of Millipore Corp.) equipped with an ultrafiltration filter whose molecular weight cut-off was 5,000 (Biomax PBCC 5,000NMWL: product of Millipore Corp.) and concentrated at 400 kPa. The resulting concentrate solution was thoroughly dried with freeze drying to obtain 0.86 g of a purified potassium alginate. All the operations were performed at room temperature (25° C.).

### Example 5

1.0 g of potassium alginate (SKAT-K-ULV: product of Kimica Corp.) having a weight-average molecular weight of 45,000 and a degree of coloration of the 5% by weight aqueous solution of 0.078 was dissolved into 99.0 g of water. The resulting aqueous solution was placed in a stirred cell (Stirred cell Model 8050: product of Millipore Corp.) equipped with an ultrafiltration filter whose molecular weight cut-off was 10,000 (Biomax PBCC 10,000NMWL: product of Millipore Corp.) and concentrated at 400 kPa. The resulting concentrate solution was thoroughly dried with freeze drying to obtain 0.75 g of a purified potassium alginate. All the operations were performed at room temperature (25° C.)

The degree of coloration of the 5% by weight aqueous solution, the weight-average molecular weight, the polydispersity, and the content of the molecules having a molecular weight of 1,800 or lower (% by weight) of the obtained alginic acid (salt) are shown in Table 2. The results shown in Table 2 prove that the alginic acid (salt) having a degree of coloration of the 5% by weight aqueous solution of higher than 0.040 is converted into a purified alginic acid (salt) having a degree of coloration of the 5% by weight aqueous solution of 0.040 or lower by the treatment method of the present invention.

TABLE 2

| | Example 4 | Example 5 |
|---|---|---|
| pH (1%) | 6.0 | 6.0 |
| 420 nm (5%) | 0.010 | 0.017 |
| 720 nm (5%) | 0.002 | 0.002 |
| Degree of coloration | 0.008 | 0.015 |
| Weight-average molecular weight | 50,564 | 51,438 |
| Polydispersity | 1.93 | 1.93 |
| Content (%) of molecules having a | 0.11 | 0.09 |
| molecular weight of 1,800 or lower | | |

### Example 6

The jellies containing potassium alginate having each of Formulation 1 and Formulation 2 shown below were prepared using the purified potassium alginate obtained in Example 1. The preparation method is following: 250.0 g of water was poured into a pot, and 6.0 g of the purified potassium alginate obtained in Example 1 and agar powder were poured into the pot immediately before the water boiled. The mixture was boiled with stirring for 2 to 3 minutes, sugar was added thereto, the mixture was further stirred, and heating was stopped. After the mixture was cooled slightly, it was poured into a mold. Lemon juice was poured into the mold, the content was stirred, and the mold was placed in a refrigerator to cool it down for 20 to 30 minutes to obtain a jelly containing potassium alginate.

### (Formulation 1)

| | | |
|---|---|---|
| Purified potassium alginate (Example 1) | 6.0 | g |
| Agar powder | 2.0 | g |
| Sugar | 15.0 | g |
| Lemon juice | 30.0 | g |
| Water | 250.0 | g |

### (Formulation 2)

| | | |
|---|---|---|
| Purified potassium alginate (Example 1) | 10.0 | g |
| Agar powder | 2.0 | g |
| Sugar | 15.0 | g |
| Lemon juice | 30.0 | g |
| Water | 250.0 | g |

The thus obtained jellies containing the purified potassium alginate, despite high concentrations of potassium alginate, showed low degrees of coloration and excellent transparency.

### Example 7

The beverage containing potassium alginate having Formulation 3 shown below was prepared using the purified potassium alginate obtained in Example 1. The preparation method is following: 2.0 g of the purified potassium alginate obtained in Example 1 was dissolved in 198.0 g of water. The pH of the solution was adjusted to 4.0 with citric acid. Then, 0.080 g of lemon flavor was further added to the solution and dissolved under stirring to obtain a beverage containing the potassium alginate.

### (Formulation 3)

| | |
|---|---|
| Purified potassium alginate (Example 1) | 2.0 g |
| Citric acid | q.s. to pH 4.0 |
| Lemon flavor | 0.080 g |
| Water | 198.0 g |

The thus obtained beverage containing the purified potassium alginate, despite a high concentration of potassium alginate, showed a low degree of coloration and excellent transparency.

### Comparative Example 5

Jellies containing potassium alginate were prepared in the same manner as in Example 4. The potassium alginate having a weight-average molecular weight of 45,000 used in Comparative Example 1 (SKAT-K-ULV: product of Kimica Corp.) was used.

### (Formulation 4)

| | | |
|---|---|---|
| Untreated potassium alginate | 6.0 | g |
| Agar powder | 2.0 | g |
| Sugar | 15.0 | g |
| Lemon juice | 30.0 | g |
| Water | 250.0 | g |

### (Formulation 5)

| | | |
|---|---|---|
| Untreated potassium alginate | 10.0 | g |
| Agar powder | 2.0 | g |
| Sugar | 15.0 | g |
| Lemon juice | 30.0 | g |
| Water | 250.0 | g |

The coloration of the obtained jellies containing potassium alginate was apparently recognized.

### Comparative Example 6

A beverage containing potassium alginate was prepared in the same manner as in Example 5. The potassium alginate having a weight-average molecular weight of 45,000 used in Comparative Example 1 (SKAT-K-ULV: product of Kimica Corp.) was used.

### (Formulation 6)

| | |
|---|---|
| Untreated potassium alginate | 2.0 g |
| Citric acid | q.s. to pH 4.0 |
| Lemon flavor | 0.080 g |
| Water | 198.0 g |

The coloration of the obtained beverage containing potassium alginate was apparently recognized.

1: A depolymerized alginic acid or a salt thereof having a weight-average molecular weight of 300,000 or lower, wherein a degree of coloration, which is defined as the difference in absorbance at 420 nm and 720 nm when a 5% by weight aqueous solution of the alginic acid or a salt thereof is subjected to absorption spectrophotometry using a 1-cm cell, is 0.040 or lower.

2: The depolymerized alginic acid or a salt thereof according to claim 1, which has a weight-average molecular weight of from 10,000 to 200,000.

3: The depolymerized alginic acid or a salt thereof according to claim 1, wherein the content of alginic acid or a salt thereof having a molecular weight of 1,800 or lower is 0.3% by weight or lower.

4: The depolymerized alginic acid or a salt thereof according to claim 1, wherein the content of alginic acid or a salt thereof having a molecular weight of 1,800 or lower is 0.001 to 0.3% by weight.

5: A depolymerized alginic acid or a salt thereof having a weight-average molecular weight of 300,000 or lower, comprising 0.001 to 0.3% by weight of alginic acid or a salt thereof having a molecular weight of 1,800 or lower.

6: A food comprising the depolymerized alginic acid or a salt thereof according to claim 1.

7: A beverage packed in a container, comprising the depolarized alginic acid or a salt thereof according to claim 1.

8: A method of producing a purified alginic acid or a salt thereof, comprising adjusting the pH of an aqueous solution of a raw material depolymerized alginic acid or a salt thereof having a weight-average molecular weight of 300,000 or lower to 1 to 3.5 and isolating a resulting precipitate.

9: A method of producing a purified alginic acid or a salt thereof, comprising treating an aqueous solution of a raw material depolymerized alginic acid or a salt thereof having a weight-average molecular weight of 300,000 or lower with an ultrafiltration membrane having a molecular weight cut-off of 2,000 to 30,000.

10: The method of producing a purified alginic acid or a salt thereof according to claim 8, wherein a degree of coloration, which is defined as the difference in absorbance at 420 nm and 720 nm when a 5% by weight aqueous solution of said alginic acid or a salt thereof is subjected to absorption spectrophotometry using a 1-cm cell, is 0.040 or lower.

11: The depolymerized alginic acid or a salt thereof according to claim 2, wherein the content of alginic acid or a salt thereof having a molecular weight of 1,800 or lower is 0.3% by weight or lower.

12: The depolymerized alginic acid or a salt thereof according to claim 2, wherein the content of alginic acid or a salt thereof having a molecular weight of 1,800 or lower is 0.001 to 0.3% by weight.

13: The method of producing a purified alginic acid or a salt thereof according to claim 9, wherein a degree of coloration, which is defined as the difference in absorbance at 420 nm and 720 nm when a 5% by weight aqueous solution of said alginic acid or a salt thereof is subjected to absorption spectrophotometry using a 1-cm cell, is 0.040 or lower.
